(19) United States
(12) Patent Application Publication
(10) Pub. No.: US 2010/0088193 A1
(43) Pub. Date: Apr. 8, 2010

(54) Method And Apparatus For Facilitating Purchase Decisions

(76) Inventor: Phillip A. White, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/575,824

(22) Filed: Oct. 8, 2009

Related U.S. Application Data
(60) Provisional application No. 61/103,649, filed on Oct. 8, 2008.

(51) Int. Cl. G06Q 30/00; G01S 19/13; G06K 7/10

(52) U.S. Cl. 705/26; 342/357.09; 342/357.08; 235/462.01

(57) ABSTRACT

In a purchase decision system and method, GPS data regarding a current geographical location of a device is output and either the GPS data or information regarding the current geographical location of the device based on the GPS data is transmitted. Data regarding items available for acquisition within a predetermined or programmed distance of the current geographical location is received and stored. Bar code data is then scanned and compared to at least some of the stored data. At least some of the stored data is displayed based on the comparison.

### CROSS REFERENCE TO RELATED APPLICATION

This application claims priority from U.S. Provisional Patent Application No. 61/103,649, filed Oct. 8, 2008, which is incorporated herein by reference.

### BACKGROUND OF THE INVENTION

1. Field of the Invention

The present invention relates to a method and system that enables a user to determine items to purchase, especially food product items.

2. Description of Related Art

Heretofore, it is believed that no means existed for wirelessly placing orders for product or items based on availability of the item at a vendor location, especially a vendor location within a predetermined or programmed distance of the wireless device utilized to place the order. In addition, heretofore, it is believed that no means existed that facilitated wireless, dynamic auctioning of items, such as food items, from establishments, such as restaurants.

It would therefore be desirable to provide a system and method that facilitated wireless ordering of an item from a vendor and/or wireless auctioning of items, such as food items, from establishments, such as restaurants.

### SUMMARY OF THE INVENTION

The invention is a purchase decision device that comprises in combination: a GPS receiver operative for outputting GPS data; a user interface; an RF transceiver; computer memory; and a controller operatively coupled with the GPS receiver, the user interface, the RF transceiver and the computer memory, the controller operative under the control of a control program stored in the computer memory for storing in the computer memory data limited to items available for acquisition within a predetermined distance of the device based on a geographical location of the device determined from the GPS data.

The RF transceiver can be operative under the control of the controller for receiving the data regarding the items available for acquisition for storage in the memory in response to transmitting either the GPS data or information regarding the geographical location of the device based on the GPS data.

The data regarding the items available for acquisition can be transmitted via a server/PC.

The device can further include a bar code reader operative for scanning bar code data under the control of the controller which, in response to determining that the scanned bar code data matches data stored in the computer memory, causes information related to said stored data to be displayed on the user interface.

The invention is also a purchase decision method that comprises: (a) a controller of a mobile device receiving GPS data regarding a current geographical location of the mobile device; (b) the controller causing either the GPS data or information regarding the current geographical location of the mobile device based on the GPS data to be wirelessly transmitted; (c) responsive to the transmission in step (b), the controller wirelessly receiving data regarding at least one item available for acquisition within a predetermined or programmed distance of the current geographical location; (d) the controller storing the data received in step (c) in a memory of the mobile device; (e) the controller causing a bar code scanner of the mobile device to scan bar code data; (f) the controller comparing the scanned bar code data to at least some of the stored data; and (g) the controller causing at least some of the stored data to be displayed on a display of the mobile device based on the comparison in step (f).

The invention is also a purchase decision system that comprises in combination a mobile device including a GPS receiver operative for outputting GPS data, a user interface, an RF transceiver, computer memory; and a controller operatively coupled with the GPS receiver, the user interface, the RF transceiver and the computer memory; and a server/PC in wireless communication with the mobile device, wherein the server/PC is operative for wirelessly receiving from the mobile device the GPS data from which the geographical location of the mobile device can be determined or information regarding the geographical location of the mobile device based on the GPS data, for retrieving from a database at least one establishment within a predetermined or programmed distance of the geographical location of the mobile device, for transmitting a bid query related to said establishment, for receiving a bid in response to said query, and for communicating said bid to the mobile device for storage in the computer memory thereof and for display of said bid or a portion thereof via the user interface.

The at least one establishment can be a restaurant.

The invention is also a purchase decision method that comprises: (a) a server/PC receiving a geographical location of a mobile device determined based on GPS data; (b) the server/PC storing data regarding one or more establishments determined to be within a predetermined or programmed distance of the geographical location of the mobile device received in step (a); (c) the server/PC transmitting a bid query to at least one establishment determined to be within the predetermined or programmed distance of the geographical location of the mobile device in step (b); and (d) the server/PC transmitting to the mobile device each bid generated by or on behalf of each establishment responding to the bid query of step (c).

The one or more establishments can be restaurants.

The method can further include: (e) the server/PC receiving from the mobile device a request for a revision to one of the bids; (f) the server/PC communicating the request for revision to said one bid; (g) responsive to the communicated request in step (f), the server/PC receiving a revised bid; and (h) the server/PC transmitting said revised bid to the mobile device.

Lastly, the invention is a purchase decision system that comprises in combination: a user interface; an RF transceiver; computer memory; and a controller operatively coupled with the user interface, the RF transceiver and the computer memory, the controller operative under the control of a control program stored in the computer memory for storing in the computer memory data regarding items available for acquisition, wherein the controller is responsive to the selection of one of said items via the user interface for communicating said selection via the RF transceiver for receipt by a vendor of said item.

### BRIEF DESCRIPTION OF THE DRAWINGS

FIG. 1 is a schematic diagram of a system for facilitating purchase decisions in accordance with the present invention; and

FIG. 2 is a detailed block diagram of the hand-held device shown in FIG. 1.

### DETAILED DESCRIPTION OF THE INVENTION

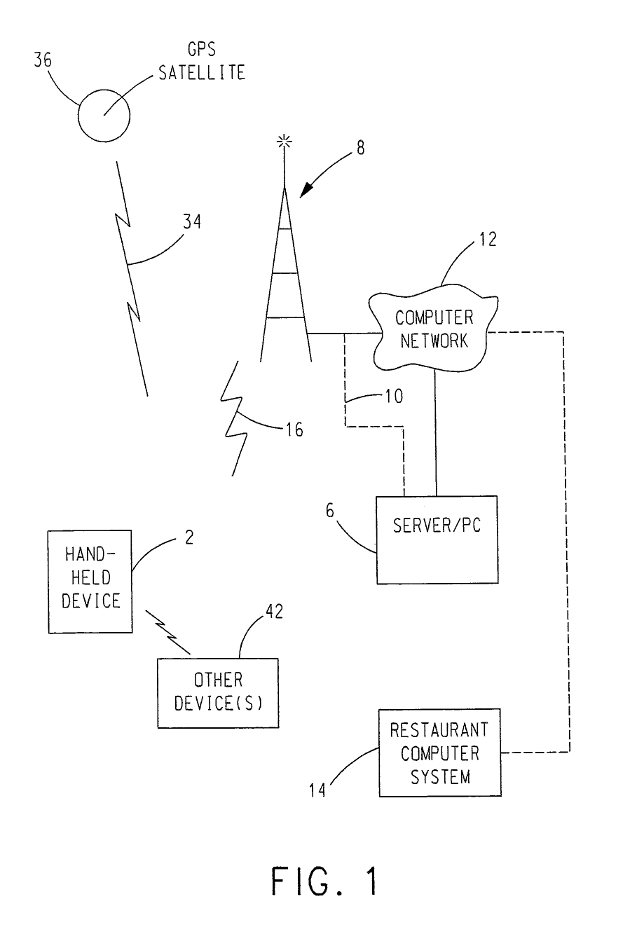

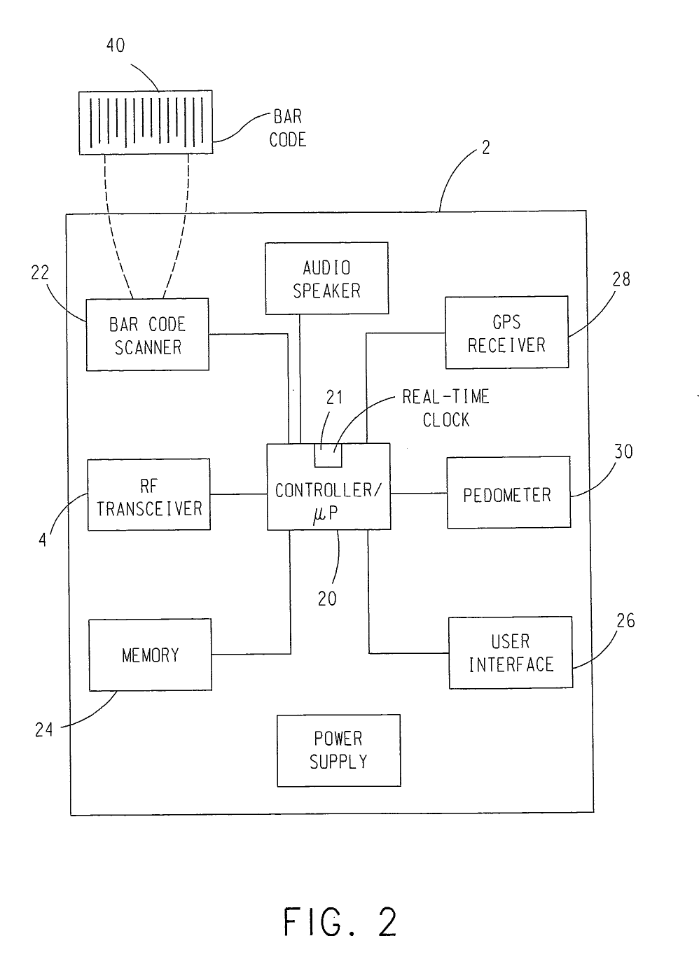

With reference to FIGS. 1 and 2, the present invention is realized in a hand-held device 2 that includes an RF transceiver 4 for wirelessly communicating with a server/personal computer (PC) via an antenna means 8. In a desirable embodiment, antenna means 8 is representative of a cellular telephone tower that is connected to a cellular telephone network which in turn is connected to server/PC 6. Antenna means 8 can be connected to server/PC 6 either directly, as shown by dashed line 10, or via a computer network 12. Computer network 12 can be any suitable and/or desirable wired and/or wireless computer network. Examples of such computer network include a local area network, a wide area network, the internet, and/or combinations thereof.

Server/PC 6 can be connected to a restaurant computer system 14 via computer network 12 and/or any suitable and/or desirable computer network.

With reference to FIG. 2 and with continuing reference to FIG. 1, hand-held device 2 includes a controller/microprocessor (μP) 20 which is connected to RF transceiver 4, a barcode scanner 22, memory 24, a user interface 26, an optional GPS receiver 28, and an optional pedometer 30.

Barcode scanner or reader 22 is of a conventional type and will not be described further herein.

RF transceiver 4 is operative for bi-directionally communicating with antenna means 8 in any suitable and/or desirable manner then in effect. For example, if antenna means 8 represents a means for receiving and transmitting cellular telephone signals, RF transceiver 4 is operative for transmitting and receiving RF signals 16 to and from antenna means 8 utilizing a suitable cellular telephone protocol.

Memory 24 can comprise any suitable and/or desirable memory or combination thereof. For example, memory 24 can include flash memory, RAM memory, EPROM memory, and the like, and/or combinations thereof.

User interface 26 includes a display screen for displaying user information. Controller 20 can be operative for causing the display of user interface 26 to display icons, text, etc. that a user can touch to activate certain functions of hand-held device 2. Display screen can utilize green, yellow and red color indicators. Also or alternatively, user interface 26 can include input keys (a keyboard), a scroll wheel, and/or any other suitable and/or desirable means to facilitate interaction between controller 20 and a user.

GPS receiver 28 can be operative for receiving GPS signals from one or more GPS satellites 36 in a manner known in the art that enables a user of hand-held device 2 to establish his longitude and latitude position at a geographical point on the earth's surface in a manner known in the art. Memory 24 can store geospatial maps that work in combination with the data received by GPS receiver to enable controller 20 to display on the visual display of user interface 26 the geospatial location of hand-held device 2 with regard to surrounding geographical features, such as, roads, buildings, and the like.

Having described the physical environment in which hand-held device 2 exists, the operation of hand-held device 2 in accordance with various embodiments of the present invention will now be described.

In general use, hand-held device 2 is utilized by a user as an aid to deciding which foods to purchase and/or to consume. To this end, hand-held device 2, either alone or in combination with server/PC 6 stores a dietary profile for the user of hand-held device 2. This dietary profile can be selected from one of a number of pre-established dietary profile and/or can be a customized dietary profile created especially for the user of hand-held device 2, either by the user or a third-party (e.g., a nutritionist). Once created, the dietary profile is utilized as a set of parameters for the user of hand-held device 2 when making a food purchase and/or consumption decision. For example, suppose the user's dietary profile establishes a 2,000 calorie per day diet with certain limits on the amount of fat that can be consumed in any day. When the user goes to a restaurant, the user can retrieve from hand-held device 2 via, but not limited to, a touch screen, keypad or barcode scanning a particular menu item's nutrition and ingredient facts such as the number of calories, fat, proteins, carbohydrates, sodium, MSG, hydrogenated oil, artificial colors and the like for comparison against the user's dietary profile. If the menu item does not exceed each of the then available limits in the user's dietary profile, or does not contain unacceptable ingredients, the hand-held device can output an appropriate audio and/or visual signal that indicates to the user that it is acceptable to purchase/consume the menu item. For example, if the menu item is a breakfast item and this is the user's first meal of the day, the user is able to choose the menu item that fits within the pre-established limits for any one or a number of parameters in the dietary profile. For example, if the user has a 2,000 calorie per day limit and the menu item under consideration has 700 calories, then the user is able to indicate to hand-held device 2 that he is going to purchase the item whereupon hand-held device 2 automatically subtracts 700 calories from the 2,000 calorie daily total and the difference (i.e., 1,300 calories) is available for display on the hand-held device to signify to the user that he is only able to consume an additional 1,300 calories for the remainder of the day without exceeding the maximum calorie intake established by the dietary profile. Another scenario is the user's dietary profile is set to notify user of any food products' ingredients containing, for example, MSG and the information for the food item under consideration is retrieved via the hand-held device. The hand-held device gives a color indication of red to signify that this product does not fit within the dietary profile parameters because the food product contains a disallowed ingredient.

The entry of food facts and nutritional information can be accomplished manually via user interface 26. Also or alternatively, it is envisioned that one or more menu items on a restaurant menu will have a barcode associated therewith that includes dietary information such as the nutrition facts and ingredients list regarding the menu item, such as, without limitation, calories, grams of fat, grams of protein, grams of carbohydrates, hydrogenated oil, artificial colors and the like. Thus, by simply utilizing barcode scanner 22 to scan a barcode 40 on a menu, information regarding the menu item associated with the barcode is quickly and easily input into hand-held device 2. This method will be applicable in grocery stores, convenience stores, restaurants and at home. Entry of nutritional information will also be accomplished by scanning barcodes from a printed uniquely designed barcode reference book that will list restaurant items and corresponding barcodes and any general use food items that are not normally found with a barcode (e.g., fresh fruits and vegetables).

The display of daily caloric intake including the optional display of number of grams of fat, number of grams of protein and number of grams of carbohydrates comprising the daily caloric intake can be displayed on the display of hand-held device in any suitable and/or desirable manner, such as a numerical display or a bar graph. Similarly, when the user selects a food item, the calories, grams of fat, grams of protein and/or grams of carbohydrate can be subtracted from the daily total to act as a visual reminder to the user of the remaining calories, fat, protein and/or carbohydrates the user is able to assimilate during the day. The display can utilize a green, yellow or red light system, indicating acceptable or unacceptable food items.

In operation, should the user enter into hand-held device 2 a food item that causes the daily dietary profile for the user to be exceeded, either in terms of their macro-nutrients or micro-nutrients, hand-held device 2 will output a suitable audio and/or visual signal that informs the user that the selected menu item will exceed the user's dietary daily profile. Hand-held device will also indicate if user isn't meeting desired micro-nutrient (vitamins, minerals) intake levels established in their dietary profile. User would then be able to select more appropriate foods to meet those goals.

Hand-held device 2 can include a real time clock 21 for storing and incrementing a time of day. At the end of each 24-hour interval, controller 20 can utilize the information from real time clock 21 to reestablish the user's dietary daily profile for the ensuing 24-hour interval.

Thus, as can be seen, the hand-held device 2 of the present invention enables the user to establish a daily dietary profile. When making a selection of a food item, the user can then input the information regarding the food item into hand-held device 2 which can calculate and analyze information regarding the food item in the user's daily dietary profile to arrive at a remainder number of calories, fat, protein, sodium and/or carbohydrates the user can assimilate during the day while remaining within the user's dietary profile parameters. If the user exceeds the dietary profile in any one or more of these areas, hand-held device can output a suitable signal to warn the user of such. Hence, hand-held device 2 enables the user thereof to quickly and easily control their food intake against a pre-established user's dietary profile.

Hand-held device 2 can store the user's dietary profile in memory 24 and/or on server/PC 6. Similarly, barcode information regarding one or more, desirably a number, of food items can be stored in memory 24 of hand-held device 2 and/or at server/PC 6. Each time the user indicates to hand-held device 2 the selection of a food item for consumption and/or purchase, this selection can ultimately be stored at server/PC 6 in a user account (record) established for the user. The transfer of this data can occur on or about the time the user indicates to hand-held device 2 that he has selected the food item for consumption. Also or alternatively, one or more food item selections made at hand-held device by the user can be transmitted to server/PC 6 regularly (e.g., daily, weekly, etc.) or irregularly (e.g., when memory 24 is becoming full). The user account established at server/PC 6 for each user of a unique hand-held device 2 can be maintained for any suitable and/or desirable interval of time, including the lifetime of the user, as an aid to tracking changes in dietary habits and/or as an aid to correlating any diseases the user may experience to the user's diet.

Another benefit of the hand-held device 2 of the present invention is that it allows for correlation between a user's weight loss and a user's food consumption. For example, if the user is staying within the dietary guidelines established by the user's daily dietary profile, the user may be expected to lose (or gain) weight at a specific rate. However, if there is a lack of reasonable correlation between the user's loss (or gain) of weight and the user's recording of food intake via hand-held device 2, this lack of correlation may be an indication that the user is not following a prescribed dietary plan.

To this end, it is envisioned that hand-held device 2 can be programmed to recommend specific food items or groups of food items at specific times of the day for consumption by the user in order to maintain the user on a prescribed daily dietary profile or plan. Thus, for example, if the user is to eat six meals a day at prescribed times, hand-held device can output a suitable signal indicating to the user that it is time to eat. Also or alternatively, hand-held device can output an indication of the types of food items the user should be eating each prescribed time.

The information regarding the relationship between barcodes and food items can be stored in hand-held device 2, at server/PC 6, and/or combinations thereof. For example, hand-held device 2 can be programmed with a large number of barcodes that correlate to food items. In the event hand-held device scans a barcode that does not include a code stored in hand-held device 2, hand-held device 2 can communicate with server/PC via antenna means 8 to retrieve the menu item information related to the code from server/PC 6.

Herein, for the purposes of storing data regarding barcodes, user's selection of food items, user's dietary profile, and the like, each hand-held device 2 and server/PC 6 can be considered a distributed database. The decision where to store each bit of information related to the operation of hand-held device 2 in accordance with the present invention can be made in any manner deemed suitable and/or desirable by one of ordinary skill in the art.

Desirably, server/PC 6 includes a large database of food items (including restaurant menu items). Moreover, it is envisioned that server/PC 6 will include for a large number of restaurants, some or all of the food items (menu items) available at each said restaurant, or restaurant chain. When a user is making a decision which restaurant to patronize, the user can access the food items or menu items available at said restaurant at hand-held device 2 from server/PC 6. To this end, the food items and/or menu items can be downloaded into hand-held device 2 and/or be accessible to hand-held device 2 from server/PC 6 via antenna means 8. Each food item of said restaurant can include relevant dietary information, such as, without limitation, calories, grams of fat, grams of protein and/or grams of carbohydrate, that enable the user of hand-held device 2 to make an informed decision which food item (or menu item) to order.

When a user indicates to hand-held device 2 that he will be ordering a specific menu item from a restaurant, the dietary information regarding the food item can be subtracted from the user's daily dietary profile to determine whether the user is within his daily dietary profile or has exceeded his daily dietary profile in one or more areas.

In one alternative embodiment, hand-held device 2 can be programmed whereupon when the user makes a selection of a food item (menu item) regarding a restaurant the user intends to patronize, hand-held device can communicate this selection to server/PC 6 via antenna means 8. Server/PC 6 in turn can communicate the user's selection to the restaurant computer system 14 of the restaurant the user intends to patronize whereupon the restaurant has pre-notice of the user's arrival and food item the user intends to order.

As discussed above, hand-held device 2 can optionally include a GPS receiver 28. GPS receiver 28 can be utilized by hand-held device 2 to limit the information that is automatically available to the user of hand-held device 2 to only those food items that are accessible within a pre-determined geographical distance of the current location of hand-held device 2. In this manner, the amount of information available to or programmed into hand-held device 2 can be limited to only that data which is most likely to be utilized by the user of hand-held device 2. For example, if by way of GPS receiver 28, controller 20 determines that hand-held device 2 is at a specific geographical location, controller 20 by way of RF transceiver 4 can access and/or download information regarding restaurants within a pre-determined distance of the current location of hand-held device 2. This data can include for each restaurant food item (menu item), information available at each restaurant and barcode information regarding each food item. Thus, by way of the visual display of user interface 26, the user of hand-held device 2 can navigate to each restaurant utilizing a graphical user interface to evaluate the food items available at said restaurant and to indicate to hand-held device whether the user will be consuming any of said food item.

The hand-held device can include the optional pedometer 30. The output of pedometer 30 can be utilized to modify the user's dietary profile in accordance with its output. For example, if the user's dietary profile is set to 2,000 calories per day based upon a sedentary lifestyle, if the user undertakes a walking or running program that consumes an additional 500 calories per day above the user's caloric intake for a sedentary lifestyle, controller 20 can modify the user's dietary profile to account for the additional calories utilized by the user. In this example, controller 20 can increase the amount of calories consumable by the user in a particular day from 2,000 calories to 2,500 calories.

The user's daily dietary profile can also or alternatively include a set of disallowed food items and possible allowed alternatives. For example, assume the user is a diabetic who is not permitted to drink sugary soft drinks. The user's daily dietary profile can include this information whereupon if the user enters or scans a barcode for a sugary soft drink, hand-held device 2 can output a suitable audio and/or visual signal to remind the user that the food item is not allowed in his dietary profile and, at the same time, can output a permitted alternative, such as a diet soft drink.

As can be seen, the present invention comprises a hand-held device 2 in radio communication with a server/PC 6 via an antenna means 8. Hand-held device 2 and server/PC 6 can operate as standalone devices or as a distributed database for storing data regarding the operation of hand-held device in accordance with the present invention. Hand-held device can be programmed to store a dietary profile for a user. This dietary profile can be for any suitable and/or desirable period of time, for example, a day, and can include recommended information regarding the user's daily dietary profile, including, without limitation, caloric intake, fat intake, protein intake and/or carbohydrate intake. Data regarding food items (or menu items) can be input into hand-held device 2 by the user via user interface 26 or via a barcode scanner 22 scanning a barcode on the food or menu item. By appropriate manipulation of user interface 26, the user can inform hand-held device 2 of the rejection or selection of the food item input into hand-held device 2. When the user indicates that the input food item is being selected, nutritional information regarding the food item can be analyzed and calculated against the user's dieting profile in order to keep a running total of how many additional calories, fats, proteins, carbohydrates etc., the user is able to ingest while staying within the limits established for the dietary profile. If, during any particular scan of a food item, hand-held device 2 and/or server/PC 6 determines that the user has exceeded a particular requirement of the user's dieting profile, e.g., macro-nutrients or micro-nutrients, hand-held device 2 can output a suitable audio and/or visual signal to inform the user of such.

Data regarding food items selected by the user of hand-held device 2 can be regularly or irregularly transmitted to server/PC 6 for storage in connection with a database established for the user of hand-held device 2. This stored data can be then utilized to correlate the user's compliance with the dietary profile and/or for helping to establish any relationship between a user's long-term diet and the user's health or any disease the user may have.

Hand-held device can include a GPS receiver 28 that is utilized by controller 20 and/or server/PC 6 to determine which barcode data and related food item information should be automatically accessible to hand-held device 2 based upon a pre-determined geographical distance from the current location of hand-held device 2 as determined by the data output by GPS receiver 28 to controller 20. Thus, as hand-held device 2 is moved from geographical area to geographical area, the information available to hand-held device regarding food items available within a pre-determined distance of its current geographical location can be automatically updated to avoid having potentially unnecessary data accessible to hand-held device 2.

Hand-held device 2 can be programmed to permit a user thereof to access food items and/or menu items available at a restaurant of interest and to assess the calories, fat, protein and/or carbohydrates in each food item with a view to enabling the user to decide whether or not to order the food item. Should the user decide to order the food item, the user can indicate such by the user interface 26 of hand-held device 2 whereupon hand-held device 2 will communicate with the restaurant computer system and pre-place the order therewith. In other words, by simply selecting an item to ingest that is available at a particular restaurant, hand-held device 2 can communicate this data to the restaurant via server/PC 6, whereupon the restaurant can make plans to serve the item to the user upon arrival. The selection and automatic ordering of a food item from a restaurant can, if desired, be conditioned upon the food product being allowed by the user's dietary dieting profile. Thus, if the user has exceeded a particular parameter of the user's dietary profile for the day, the order will not be automatically placed. However, the user will have the ability to override this action if desired.

Also or alternatively, if the user selects an item which is not allowed by the user's dietary profile, either because it exceeds a user's intake for a particular parameter (calories, fat, protein and/or carbohydrates) for a day or is not permitted by the user's dietary profile for medical reasons, hand-held device 2 can be programmed whereupon one or more alternate selections can be output on the display of user interface 26 for alternative selection by the user of hand-held device 2. In this manner, a user is presented with viable alternatives to his initial, disallowed selection.

Input into hand-held device 2 of consumed food items can be stored in a user file on server/PC 6. In certain instances, such as when a user is on a weight loss diet, this stored information can be utilized to assess whether or not the user is faithfully following the diet. For example, if the food items input into hand-held device by the user over a period of time have a caloric intake that suggests that the user should be losing weight, but the user is not losing weight, it can be deduced that the user is in fact not following the diet properly.

Hand-held device 2, including GPS receiver 28, in combination with server/PC 6 can also or alternatively be programmed to enable restaurants (or other establishments) to bid for the business of the user of hand-held device 2 in an auction environment. Specifically, via a user interface 26 of a suitably programmed hand-held device 2, a user of the hand-held device 2 can indicate to a suitably programmed server/PC 6 a willingness to accept one or more bids for one or more goods and/or services (e.g., without limitation, food product(s)/menu items) of one or more establishments (e.g., without limitation, restaurants) based on the current geographical location of hand-held device 2 determined by GPS receiver 28. Thus, for example, in response to a user of hand-held device 2 indicating to user interface 26 a willingness to accept bids for one or more goods and/or services, hand-held device 2 outputs to server/PC 6 a solicitation for said bids along with the current geographical location of hand-held device 2 determined by GPS receiver 28. In response to receiving this solicitation along with the current geographical location of hand-held device 2, server/PC 6 can output to eligible establishments determined to be accessible to the user a query soliciting bids for the user's business.

Establishments eligible to receive a query may be stored in a database accessible to server/PC 6. Suitable criteria may be established for selecting each establishment in response to a solicitation and current geographical location of a hand-held device 2. For example, each establishment within a predetermined distance of the current geographical location of hand-held device 2 can be selected. Also or alternatively, each establishment may be selected based upon unique criteria associated with the establishment. For example, for an establishment, such as a restaurant, with drive-through service, the unique criteria may be a willingness of the establishment to bid on the business of each user within a 2-mile radius of the current geographical location of the hand-held device 2 of said user. In contrast, for an establishment, such as a restaurant, with only walk-in service, the unique criteria may be a willingness of the establishment to bid on the business of each user within a 1-mile radius of the current geographical location of the hand-held device 2 of said user. However, this is not to be construed as limiting the invention since the use of any other suitable and/or desirable criteria to determine which establishments to select to receive a query is envisioned.

Once the establishment(s) that are eligible to receive a query have been selected, server/PC 6 communicates to the hand-held device 2 the bid(s) of some or all of the eligible establishment(s). Each bid can be displayed on the user interface 26 of the hand-held device 2 in any suitable and/or desirable manner.

A bid communicated to hand-held device 2 in response to a query can be a predetermined bid that is stored in a suitable database accessible to server/PC 6, such as, without limitation, a database of server/PC 6 itself, a database of one or more computer systems associated with a selected establishment, such as, without limitation, one or more restaurant computer systems 14, or some combination thereof. However, this is not to be construed as limiting the invention. Also or alternatively, a bid communicated to hand-held device 2 in response to the query can be generated in real-time by a user of a computer system associated with one of the selected establishments, such as, without limitation, a restaurant computer system 14.

Each bid can be in the form of a percent or monetary discount, a free or discount item (e.g., a food item), a free or discount item if certain conditions are met, etc. Nonlimiting examples of bid conditions may include, without limitation: buy-one get-one; purchase within a specified time of receiving the bid (e.g., within one hour of receiving the bid); and/or purchase within a predetermined time interval (e.g., between 2 pm and 4 pm). However, this is not to be construed as limiting since it is envisioned that other forms of bids and/or conditions may be used.

In response to hand-held device 2 receiving one or more bids from one or more establishments, some or all of said bid(s) are displayed on the user interface 26 where the user of hand-held device 2 can accept at least one of said bids in any suitable and/or desirable and/or manner, e.g., without limitation, by showing up at the establishment associated with the accepted bid, by affirmatively accepting the bid via the user interface 26, etc. Where the user accepts the bid by showing up at the establishment, the bid appearing on the user interface 26 and/or a code associated with the hand-held device 2 (e.g., a code transmitted with the bid and/or a number, such as a cellular telephone number, associated with the hand-held device 2) may be used by the establishment (e.g., via the establishment's computer system which also, desirably, has access to the bid and/or the code) to confirm the eligibility of the holder of the hand-held device 2 to accept the bid. Where the user accepts the bid via user interface 26, a code associated with the hand-held device 2 (e.g., a code transmitted with the bid and/or a number, such as a cellular telephone number, associated with the hand-held device 2) may be utilized to confirm the eligibility of the holder of the hand-held device 2 to accept the bid. However, this is not to be construed as limiting the invention since acceptance of a bid can occur in any suitable and/or desirable manner.

The user of hand-held device 2 can reject each bid by simply not showing up at the establishment that generated the bid, by not responding to the bid via the user interface 26, or by affirmatively rejecting the bid, either in person or via the user interface 26. However, this is not to be construed as limiting the invention since rejection of a bid can occur in any suitable and/or desirable manner.

Also or alternatively, in response to hand-held device 2 receiving one or more bids from one or more establishments, hand-held device 2 and server/PC 6 can be programmed to enable the user of the hand-held device 2 to further negotiate with one or more of said establishments. For example, the user may respond to a received bid by requesting via the user interface 26 a revised bid including additional consideration, such as, without limitation, a further percent or monetary discount, a different or additional free item, a different or additional free item if sufficient quantities of other items are purchased (buy-one get-one), etc. In response to receiving a request for a revised bid, an establishment can respond by either declining to submit a revised bid or by submitting a revised bid including additional consideration, either automatically or via an individual operating a computer system of the establishment. The process of hand-held device 2 receiving one or more bids, the user of hand-held device 2 requesting revised bids including additional consideration, and one or more establishments either declining to submit a revised bid or submitting a revised bid can be repeated as necessary and/or desirable.

The above-described auction environment is implemented by computer software operative on each hand-held device 2 and computer software operative on each server/PC 6 that participates in an auction event in the manner described above.

Hand-held device 2 including GPS receiver 28 can also be utilized for generating real-time marketing data for a food product. For example, server/PC 6 can be configured to record each time and geographical location a hand-held device 2 in accordance with the present invention scans a particular food product, e.g., a box of cereal, indicative of a user of a hand-held device 2 considering the product for purchase. This data regarding purchasing consideration by consumers of the particular food product can be made available for analysis and consumption in connection with decisions regarding in which geographical location(s) in which to place advertisements for the food product. Also or alternatively, the same information can be provided for a number of food products by the same manufacturer. Such information can be utilized by the manufacturer to determine which products are of interest to consumers for the purposes of advertising or developing new products having like characteristics as pre-existing products that are being considered by users of hand-held device 2.

In addition to server/PC 6 storing information regarding scanning of a food product by a consumer utilizing hand-held device 2 in consideration of purchasing the food product, server/PC 6 can also store data regarding whether users of hand-held devices 2 have indicated that they have selected or rejected the food product. Thus, in addition to being able to determine when users of hand-held devices 2 are considering the purchase of a particular food product, server/PC 6 can also store data regarding whether and how often the food product under consideration is selected or rejected by users of hand-held devices 2.

Another possible application of hand-held device 2 and server/PC 6 is for assessing how a new food product may be accepted by the marketplace. For example, the number of calories, fat, protein, sodium, carbohydrates, etc. and/or some combination thereof, can be compared to like information of food products selected by a statistically significant number of users of hand-held devices 2 to determine the potential acceptance of the new food product to users of hand-held devices 2. For example, the amount of fat, protein, sodium and/or carbohydrates in the new food product can be compared against like information for food products selected by, for example, 1,000 users of hand-held devices 2. The total number of food items selected by users of hand-held devices 2 that have an amount of calories, fat, protein, sodium and/or carbohydrates at or below the level in the new food product can be compared to the total number of food products selected in the statistical sample of users of hand-held devices 2 to determine a percentage of users that may buy the new food product. For example, if it is determined that 70% of the food products purchased by users of hand-held devices 2 have an amount of calories, fat, protein, sodium and/or carbohydrates at or below the corresponding level in the new food product, this percentage can be provided to the manufacturer of the new food product as an indication of the possibility of the desirability of the new food product. On the other hand, if it is determined that one or more of the amount of calories, fat, protein, sodium and/or carbohydrates in the new food product would only be acceptable to 30% of the purchasing decisions of the users of hand-held devices 2, this information can be provided to the manufacturer of the new food product. Based on this information, the manufacturer of the new food product can then, if desired, reengineer the new food product to increase the possibility of its desirability to the users of hand-held devices 2.

Hand-held device 2 can also have short-range wireless capability with other devices 42, such as, without limitation, scales (kitchen or bathroom) and exercise units. In operation, each of these other devices would be configured to transmit data regarding its use, in response to a user of hand-held device 2 utilizing said other device, to hand-held device 2 for subsequent dispatch to server/PC 6 via antenna means 8. For example, if a user of hand-held device 2 weighs themselves on a suitably equipped scale, said scale would dispatch the weight information to hand-held device 2 which would time-date stamp the weight and dispatch the time-date stamped weight to server/PC 6 for storage in a user account established for the user of hand-held device 2.

Similarly, if a user of hand-held device 2 has another device 42 that is a food scale, the user can place a food item on the scale, tell the scale what the food item is, whereupon the scale calculates nutritional information for the food product on the scale and then wirelessly transmits that information to server/PC 6 for storage in the user account established for the user of hand-held device 2.

Also or alternatively, it is envisioned that hand-held device 2 can be utilized to track other information including, without limitation, a user's exposure to X-rays, immunizations, medications, and the like which may be entered into hand-held device 2 by or under the control of the user thereof for storage at server/PC 6 in a user account established for the user. Server/PC 6 can be configured to track and compare X-ray exposure, immunizations, and/or medications for the user and compare the same against pre-established limits for X-rays and/or drug interaction information to determine if the user of hand-held device 2 has exceeded a limit for X-rays for a given period of time or if an immunization and/or medication will conflict with a pre-existing immunization or medication of the user. If such conflict is detected, server/PC 6 can cause a suitable audio and/or visual alarm to be generated at the hand-held device 2 of the user.

Still further, hand-held device 2, either alone or in combination with server/PC 6, can track other information regarding one or more food products, such as, without limitation: information regarding country of origin of a discrete food product such as, without limitation, meat, poultry, fruit or vegetable; whether the food product (e.g., meat and poultry) has been subject to irradiation; and/or the presence or absence of growth hormone in the food product (e.g., meat and poultry).

Thus, as can be seen, hand-held device 2 can be used as a portal to a user account of the user thereof established at server/PC 6 that acts as a common database for all health and wellness information concerning the user and as a portal for information that may be important to a user when selecting a food product.

The invention has been described with reference to exemplary embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A purchase decision system comprising in combination:
a GPS receiver operative for outputting GPS data;
a user interface;
an RF transceiver;
computer memory; and
a controller operatively coupled with the GPS receiver, the user interface, the RF transceiver and the computer memory, the controller operative under the control of a control program stored in the computer memory for storing in the computer memory data limited to items available for acquisition within a predetermined distance of the device based on a geographical location of the device determined from the GPS data.

2. The device of claim 1, wherein the controller is responsive to the selection of one of said items via the user interface for communicating said selection via the RF transceiver for receipt by a vendor of said item.

3. The device of claim 1, wherein the RF transceiver is operative under the control of the controller for receiving the data regarding the items available for acquisition for storage in the memory in response to transmitting either the GPS data or information regarding the geographical location of the device based on the GPS data.

4. The device of claim 1, wherein the data regarding the items available for acquisition is transmitted via a server/PC.

5. The device of claim 1, further including a bar code reader operative for scanning bar code data under the control of the controller which, in response to determining that the scanned bar code data matches data stored in the computer memory, causes information related to said stored data to be displayed on the user interface.

6. A purchase decision method comprising:
(a) a controller of a mobile device receiving GPS data regarding a current geographical location of the mobile device;
(b) the controller causing either the GPS data or information regarding the current geographical location of the mobile device based on the GPS data to be wirelessly transmitted;
(c) responsive to the transmission in step (b), the controller wirelessly receiving data regarding at least one item available for acquisition within a predetermined or programmed distance of the current geographical location;
(d) the controller storing the data received in step (c) in a memory of the mobile device;
(e) the controller causing a bar code scanner of the mobile device to scan bar code data;
(f) the controller comparing the scanned bar code data to at least some of the stored data; and
(g) the controller causing at least some of the stored data to be displayed on a display of the mobile device based on the comparison in step (f).

7. A purchase decision method comprising:
(a) a server/PC receiving a geographical location of a mobile device determined based on GPS data;
(b) the server/PC storing data regarding one or more establishments determined to be within a predetermined or programmed distance of the geographical location of the mobile device received in step (a);
(c) the server/PC transmitting a bid query to at least one establishment determined to be within the predetermined or programmed distance of the geographical location of the mobile device in step (b); and
(d) the server/PC transmitting to the mobile device each bid generated by or on behalf of each establishment responding to the bid query of step (c).

8. The system of claim 7, wherein the one or more establishments are restaurants.

9. The method of claim 7, further including:
(e) the server/PC receiving from the mobile device a request for a revision to one of the bids;
(f) the server/PC communicating the request for revision to said one bid;
(g) responsive to the communicated request in step (f), the server/PC receiving a revised bid; and
(h) the server/PC transmitting said revised bid to the mobile device.
